(19) United States
(12) Patent Application Publication
(10) Pub. No.: US 2013/0141197 A1
(43) Pub. Date: Jun. 6, 2013

(54) RARE-EARTH PERMANENT MAGNET AND METHOD FOR MANUFACTURING RARE-EARTH PERMANENT MAGNET

(71) Applicants: Takashi Ozaki, Ibaraki-shi (JP); Katsuya Kume, Ibaraki-shi (JP); Toshiaki Okuno, Ibaraki-shi (JP); Izumi Ozeki, Ibaraki-shi (JP); Tomohiro Omure, Ibaraki-shi (JP); Keisuke Taihaku, Ibaraki-shi (JP)

(72) Inventors: Takashi Ozaki, Ibaraki-shi (JP); Katsuya Kume, Ibaraki-shi (JP); Toshiaki Okuno, Ibaraki-shi (JP); Izumi Ozeki, Ibaraki-shi (JP); Tomohiro Omure, Ibaraki-shi (JP); Keisuke Taihaku, Ibaraki-shi (JP)

(73) Assignee: NITTO DENKO CORPORATION, Ibaraki-shi, Osaka (JP)

(21) Appl. No.: 13/817,104

(22) PCT Filed: Mar. 15, 2012
(86) PCT No.: PCT/JP2012/056717

§ 371 Date: Feb. 14, 2013

(30) Foreign Application Priority Data
Jun. 24, 2011 (JP) 2011-140917

(51) Int. Cl. H01F 41/02; H01F 7/02

(52) U.S. Cl. CPC H01F 41/0266; H01F 7/02
USPC 335/302; 419/38

(57) ABSTRACT

There are provided a rare-earth permanent magnet and a manufacturing method of the rare-earth permanent magnet capable of preventing deterioration of magnet properties. In the method, magnet material is milled into magnet powder, and the magnet powder is mixed with a binder made of a hydrocarbon to prepare slurry 12, and one or more kinds of organic solvents selected from a group of organic compounds consisting of hydrocarbons. Next, the slurry 12 is formed into a sheet-like shape to obtain a green sheet 13. After that, the green sheet 13 is held for a predetermined length of time at binder decomposition temperature in a non-oxidizing atmosphere so as to cause depolymerization reaction or the like to the binder, which turns into monomer and is removed. The green sheet 13 with the binder removed is sintered by raising temperature up to sintering temperature. Thereby a permanent magnet 1 is obtained.

### TECHNICAL FIELD

The present invention relates to a rare-earth permanent magnet and a manufacturing method of the rare-earth permanent magnet.

### BACKGROUND ART

In recent years, a decrease in size and weight, an increase in power output and an increase in efficiency have been required in a permanent magnet motor used in a hybrid car, a hard disk drive, or the like. To realize such a decrease in size and weight, an increase in power output and an increase in efficiency in the permanent magnet motor mentioned above, film-thinning and a further improvement in magnetic performance have been required of a permanent magnet to be buried in the permanent magnet motor.

Here, as a method for manufacturing the permanent magnet used in the permanent magnet motor, a powder sintering method is generally used. In the powder sintering method as used herein, a raw material is first pulverized with a jet mill (dry-milling) to produce a magnet powder. Thereafter, the magnet powder is placed in a mold, and press molded to a desired shape while a magnetic field is applied from the outside. Then, the solid magnet powder molded into the desired shape is sintered at a predetermined temperature (for example, 1100 degrees Celsius in a case of an Nd—Fe—B-based magnet), thereby manufacturing the permanent magnet.

However, when the permanent magnet is manufactured by the above-mentioned powder sintering method, there have been the following problems. That is to say, in the powder sintering method, it is necessary to secure a predetermined porosity in a press-molded magnet powder in order to perform magnetic field orientation. If the magnet powder having the predetermined porosity is sintered, it is difficult to uniformly contract at the time of sintering. Accordingly deformations such as warpage and depressions occur after sintering. Further, since pressure unevenness occurs at the time of pressing the magnet powder, the magnet is formed to have inhomogeneous density after sintering to generate distortion on a surface of the magnet. Conventionally, it has therefore been required to compression-mold the magnet powder to a larger size than that of a desired shape, assuming that the surface of the magnet has some distortion. Then, diamond cutting and polishing operations have been performed after sintering, for alteration to the desired shape. As a result, the number of manufacturing processes increases, and there also is a possibility of deteriorating qualities of the permanent magnet manufactured.

Specifically, when a thin-film magnet is cut out of a bulk body having a larger size as discussed above, material yield is significantly decreased. Further, a problem of large increase in man-hours has also been raised.

Therefore, as a means for solving the above problems, there has been proposed a method of manufacturing a permanent magnet through kneading a magnet powder and a binder, preparing a green sheet, and sintering the green sheet thus prepared (for instance, Japanese Laid-open Patent Application Publication No. 1-150303).

### PRIOR ART DOCUMENT

### Patent Document

Patent document 1: Japanese Laid-open Patent Application Publication No. 1-150303 (pages 3 and 4)

### DISCLOSURE OF THE INVENTION

### Problem to be Solved by the Invention

However, if an organic solvent is added for the purpose of making the magnet powder into a slurry state in a process where the magnet powder is formed into the green sheet and sintered as described in Patent Document 1, substances containing oxygen atoms included in the organic solvent are likely to remain in the magnet at sintering.

Here, as an rare-earth element (such as neodymium) in a rare-earth magnet (such as neodymium magnet) has high reactivity with oxygen, the presence of oxygen-containing substances causes the rare-earth element to bind with the oxygen to form a metal oxide at the sintering process. As a result, there occurs a problem of decrease of magnetic properties. Furthermore, binding of the rare-earth element with oxygen makes the content of the rare-earth element deficient, compared with the content based on the stoichiometric composition (for instance, Nd₂Fe₁₄B in the neodymium magnet). Consequently, alpha iron separates out in the main phase of the sintered magnet, which causes a problem of serious degradation in the magnetic properties. Specifically, the problem becomes significant if an extra amount of the rare-earth element is not included in magnet raw material, in comparison with the stoichiometric composition.

The present invention has been made to resolve the above described conventional problems and the object thereof is to provide a rare-earth permanent magnet and manufacturing method thereof capable of reducing oxygen content contained in the magnet when magnet powder is mixed with a binder and/or an organic solvent and made into a green sheet and then the green sheet is sintered, so that degradation of the magnetic properties can be prevented.

### Means for Solving the Problem

To achieve the above object, the present invention provides a rare-earth permanent magnet manufactured through steps of: milling magnet material into magnet powder; preparing slurry by mixing the magnet powder with a binder made of a hydrocarbon, and one or more kinds of organic solvents selected from a group of organic compounds consisting of hydrocarbons; obtaining a green sheet by forming the slurry into a sheet-like shape; and sintering the green sheet.

The above-described rare-earth permanent magnet of the present invention is manufactured further through a step of decomposing and removing the binder from the green sheet by holding the green sheet for a predetermined length of time at binder decomposition temperature in a non-oxidizing atmosphere, before sintering the green sheet.

In the above-described rare-earth permanent magnet of the present invention, in the step of decomposing and removing the binder, the green sheet is held for the predetermined length of time in a temperature range of 200 degrees Celsius to 900 degrees Celsius in a hydrogen atmosphere or a mixed gas atmosphere of hydrogen and inert gas.

In the above-described rare-earth permanent magnet of the present invention, in the step of milling the magnet material into the magnet powder, the magnet material is milled wet in the one or more kinds of organic solvents; and in the step of preparing the slurry, the binder is added to the one or more kinds of organic solvents mixed with the magnet powder so that the slurry is prepared.

To achieve the above object, the present invention provides a manufacturing method of a rare-earth permanent magnet comprising the steps of: milling magnet material into magnet powder; preparing a slurry by mixing the magnet powder with a binder made of a hydrocarbon, and one or more kinds of organic solvents selected from a group of organic compounds consisting of hydrocarbons; obtaining a green sheet by forming the slurry into a sheet-like shape; and sintering the green sheet.

The above-described manufacturing method of a rare-earth permanent magnet of the present invention further comprises a step of decomposing and removing the binder from the green sheet by holding the green sheet for a predetermined length of time at binder decomposition temperature in a non-oxidizing atmosphere, before sintering the green sheet.

In the above-described manufacturing method of a rare-earth permanent magnet of the present invention, in the step of decomposing and removing the binder, the green sheet is held for the predetermined length of time in a temperature range of 200 degrees Celsius to 900 degrees Celsius in a hydrogen atmosphere or a mixed gas atmosphere of hydrogen and inert gas.

In the above-described manufacturing method of a rare-earth permanent magnet of the present invention, in the step of milling the magnet material into the magnet powder, the magnet material is milled wet in the one or more kinds of organic solvents; and in the step of preparing the slurry, the binder is added to the one or more kinds of organic solvents mixed with the magnet powder so that the slurry is prepared.

### Effect of the Invention

According to the rare-earth permanent magnet of the present invention, the rare-earth permanent magnet is a sintered magnet made from a green sheet obtained by mixing magnet powder with a binder and an organic solvent and forming into a sheet-like shape. Therefore, the thus sintered green sheet uniformly contracts and deformations such as warpage and depressions do not occur to the sintered green sheet. Further, the sintered green sheet having uniformly contracted gets pressed uniformly, which eliminates adjustment process to be conventionally performed after sintering and simplifies manufacturing process. Thereby, a permanent magnet can be manufactured with dimensional accuracy. Further, even if such permanent magnets are manufactured with thinner design, increase in the number of manufacturing processes can be avoided without lowering a material yield. Further, through using one or more kinds of organic solvents selected from a group of organic compounds consisting of hydrocarbons as organic solvent, and further, using a binder composed of a hydrocarbon as binder, the oxygen content contained in the magnet at the sintering process can be reduced. As a result, formation of metal oxide at the sintering process can be suppressed, and the magnetic properties can be prevented from deteriorating.

Further, according to the rare-earth permanent magnet of the present invention, before sintering, the green sheet is held under the non-oxidizing atmosphere at the binder decomposition temperature for the predetermined length of time to decompose and remove the binder, so that carbon content of the magnet can be previously reduced. Consequently, alpha iron can be prevented from separating out in a main phase of the sintered magnet and the entirety of the magnet can be sintered densely. Thereby, decrease in the coercive force can be prevented.

Further, according to the rare-earth permanent magnet of the present invention, in the calcination process, the green sheet to which the binder has been mixed is calcined in a hydrogen atmosphere or a mixed gas atmosphere of hydrogen and inert gas. Thereby, carbon content in the magnet can be reduced reliably.

Further, according to the rare-earth permanent magnet of the present invention, oxygen content in the sintered magnet can be reduced by using one or more kinds of organic solvents selected from a group of organic compounds consisting of hydrocarbons when the magnet material is milled wet. As a result, formation of the metal oxide in the sintering process, and further, deterioration in the magnetic properties can be prevented.

According to the manufacturing method of a rare-earth permanent magnet of the present invention, the rare-earth permanent magnet is a sintered magnet made from a green sheet obtained by mixing magnet powder with a binder and an organic solvent and forming into a sheet-like shape. Therefore, the thus sintered green sheet uniformly contracts and deformations such as warpage and depressions do not occur to the sintered green sheet. Further, the sintered green sheet having uniformly contracted gets pressed uniformly, which eliminates adjustment process to be conventionally performed after sintering and simplifies manufacturing process. Thereby, a permanent magnet can be manufactured with dimensional accuracy. Further, even if such permanent magnets are manufactured with thinner design, increase in the number of manufacturing processes can be avoided without lowering a material yield. Further, through using one or more kinds of organic solvents selected from a group of organic compounds consisting of hydrocarbons as organic solvent, and further, using a binder composed of a hydrocarbon as binder, the oxygen content contained in the magnet at the sintering process can be reduced. As a result, formation of metal oxide at the sintering process can be suppressed, and the magnetic properties can be prevented from deteriorating.

Further, according to the manufacturing method of a rare-earth permanent magnet of the present invention, before sintering, the green sheet is held under the non-oxidizing atmosphere at the binder decomposition temperature for the predetermined length of time to decompose and remove the binder, so that carbon content of the magnet can be previously reduced. Consequently, alpha iron can be prevented from separating out in a main phase of the sintered magnet and the entirety of the magnet can be sintered densely. Thereby, decrease in the coercive force can be prevented.

Further, according to the manufacturing method of a rare-earth permanent magnet of the present invention, in the calcination process, the green sheet to which the binder has been mixed is calcined in a hydrogen atmosphere or a mixed gas atmosphere of hydrogen and inert gas. Thereby, carbon content in the magnet can be reduced reliably.

Further, according to the manufacturing method of a rare-earth permanent magnet of the present invention, oxygen content in the sintered magnet can be reduced by using one or more kinds of organic solvents selected from a group of organic compounds consisting of hydrocarbons when the magnet material is milled wet. As a result, formation of the metal oxide in the sintering process, and further, deterioration in the magnetic properties can be prevented.

### BRIEF DESCRIPTION OF THE DRAWINGS

FIG. 1 is an overall view of a permanent magnet according to the invention.

FIG. 2 is a view depicting an effect at sintering on a basis of improved thickness precision in a green sheet according to the invention.

FIG. 3 is a view depicting a problem at sintering with lower thickness precision in the green sheet according to the invention.

FIG. 4 is an explanatory diagram illustrating manufacturing processes of a permanent magnet according to the invention.

FIG. 5 is an explanatory diagram specifically illustrating a formation process of the green sheet in the manufacturing process of the permanent magnet according to the invention.

FIG. 6 is an explanatory diagram specifically illustrating a pressure sintering process of the green sheet in the manufacturing process of the permanent magnet according to the invention.

FIG. 7 is a table illustrating various measurement results of magnets according to embodiment 1 and comparative examples 1 and 2, respectively.

FIG. 8 is a table illustrating various measurement results of magnets according to embodiment 2 and comparative examples 3 and 4, respectively.

### BEST MODE FOR CARRYING OUT THE INVENTION

A specific embodiment of a rare-earth permanent magnet and a method for manufacturing the rare-earth permanent magnet according to the present invention will be described below in detail with reference to the drawings.

[Constitution of Permanent Magnet]

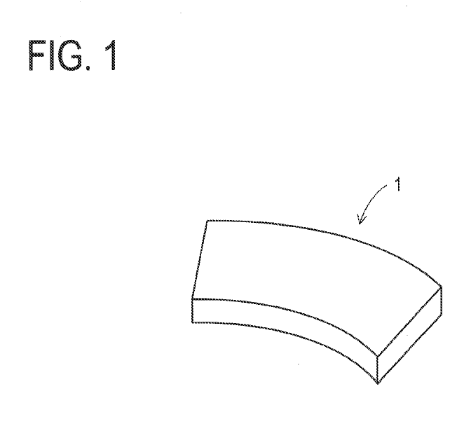

First, a constitution of a permanent magnet 1 according to the present invention will be described. FIG. 1 is an overall view of the permanent magnet 1 according to the present invention. Incidentally, the permanent magnet 1 depicted in FIG. 1 has a fan-like shape; however, the shape of the permanent magnet 1 may be changed in accordance with the shape of a cutting-die.

As the permanent magnet 1 according to the present invention, an Nd—Fe—B-based magnet may be used. Incidentally, the contents of respective components are regarded as Nd: 27 to 40 wt %, B: 1 to 2 wt %, and Fe (electrolytic iron): 60 to 70 wt %. Furthermore, the permanent magnet 1 may include other elements such as Dy, Tb, Co, Cu, Al, Si, Ga, Nb, V, Pr, Mo, Zr, Ta, Ti, W, Ag, Bi, Zn or Mg in small amount, in order to improve the magnetic properties thereof. FIG. 1 is an overall view of the permanent magnet 1 according to the present embodiment.

The permanent magnet 1 as used herein is a thin film-like permanent magnet having a thickness of 0.5 to 10 mm (for instance, 1 mm), and is prepared by sintering a formed body (a green sheet) formed into a sheet-like shape from a mixture (slurry) of magnet powder, a binder and an organic solvent as described later.

In the present invention, when preparing a green sheet, there is used a resin, long-chain hydrocarbon, fatty acid methyl ester or a mixture thereof, as the binder to be mixed with the magnet powder.

Further, if the resin is used as the binder, there are preferably used, for instance, polyisobutylene (PIB), butyl rubber (IIR), polyisoprene (IR), polybutadiene, polystyrene, styrene-isoprene block copolymer (SIS), styrene-butadiene block copolymer (SBS), poly(2-methyl-1-pentene), poly(2-methyl-1-butene), poly(alpha-methylstyrene), polybutylmethacrylate, polymethylmethacrylate, etc. Incidentally, low molecular weight polyisobutylene is preferably added to the poly(alpha-methylstyrene) to produce flexibility. Further, as resin used for the binder, there are preferably used a polymer made of hydrocarbon, having a depolymerization property and an excellent thermal decomposition property (for instance, polyisobutylene, etc) to reduce the oxygen content contained in the magnet.

Incidentally, the binder is preferably made of a resin excluding polyethylene and polypropylene so that the binder can get dissolved in a general purpose solvent such as toluene.

Meanwhile, in a case a long-chain hydrocarbon is used for the binder, there is preferably used a long-chain saturated hydrocarbon (long-chain alkane) being solid at room temperature and being liquid at a temperature higher than the room temperature. Specifically, a long-chain saturated hydrocarbon whose carbon number is 18 or more is preferably used.

Further, the amount of the binder to be added is an optimal amount to fill the gaps between magnet particles so that thickness accuracy of the sheet can be improved when forming the mixture of the magnet powder and the binder into a sheet-like shape. For instance, the binder proportion to the amount of magnet powder and binder in total in the slurry after the addition of the binder is preferably 1 wt % through 40 wt %, more preferably 2 wt % through 30 wt %, still more preferably 3 wt % through 20 wt %.

The organic solvent to be added to the magnet powder in forming the green sheet may be selected from: alcohols such as isopropyl alcohol, ethanol and methanol; lower hydrocarbons such as pentane and hexane; aromatic series such as benzene, toluene and xylene; esters such as ethyl acetate; ketones; and a mixture thereof. However, it is preferable in this invention to use one or more kinds of organic solvents selected from a group of organic compounds consisting of hydrocarbons for the purpose of reducing oxygen content contained in the magnet, to be later discussed. Here, one or more kinds of organic solvents selected from a group of organic compounds consisting of hydrocarbons include toluene, hexane, pentane, benzene, xylene, a mixture thereof and the like. For instance, toluene or hexane is used. However, the organic solvent may contain a small amount of organic compounds other than hydrocarbons.

Meanwhile, as a means for sintering the green sheet, there can be used pressure sintering, for instance. The pressure sintering includes: hot pressing, hot isostatic pressing (HIP), high pressure synthesis, gas pressure sintering, spark plasma sintering (SPS) and the like, for instance. However, it is desirable to adopt a method where sintering is performed in a shorter duration and at a lower temperature, so as to prevent grain growth of the magnet particles during the sintering. It is also desirable to adopt a sintering method capable of suppressing warpage formed in the sintered magnets. Accordingly, specifically in the present invention, it is preferable to adopt the SPS method which is uniaxial pressure sintering in which pressure is uniaxially applied and also in which sintering is performed by electric current sintering, from among the above sintering methods.

Here, the SPS method is a method of heating a graphite sintering die with a sintering object arranged inside while pressurizing in a uniaxial direction. The SPS method utilizes pulse heating and mechanical pressure application, so that the sintering is driven complexly by electromagnetic energy by pulse conduction, self-heating of the object to be processed and spark plasma energy generated among particles, in addition to thermal or mechanical energy used for ordinary sintering. Accordingly, quicker heating and cooling can be realized, compared with atmospheric heating by an electric furnace or the like, and sintering at a lower temperature range can also be realized. As a result, the heating-up and holding periods in the sintering process can be shortened, making it possible to manufacture a densely sintered body in which grain growth of the magnet particles is suppressed. Further, the sintering object is sintered while being pressurized in a uniaxial direction, so that the warpage after sintering can be suppressed.

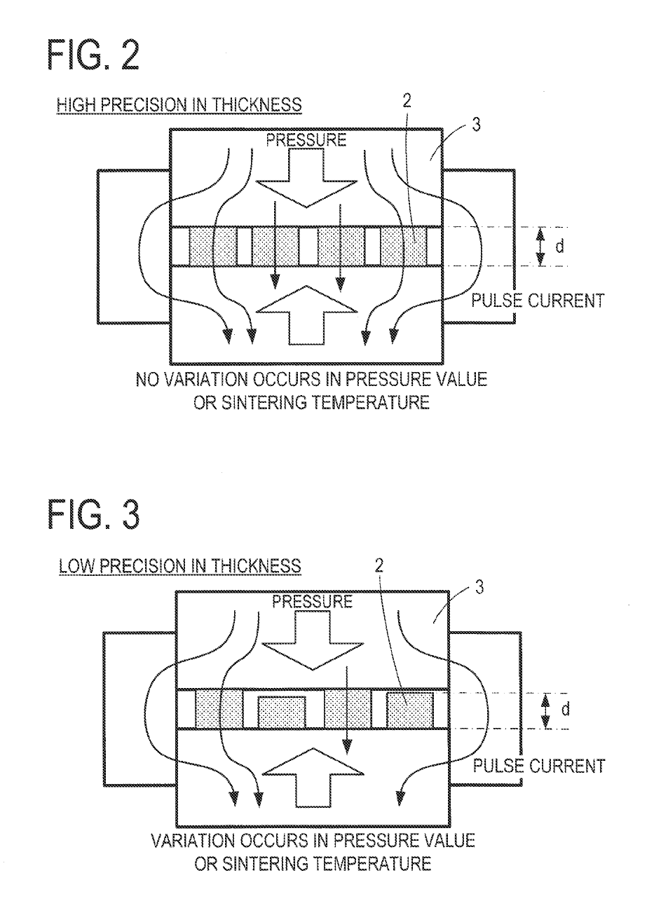

Furthermore, the green sheet is die-cut into a desired product shape (for instance, a fan-like shape shown in FIG. 1) to obtain a formed body and the formed body is arranged inside the sintering die of an SPS apparatus, upon executing the SPS method. According to the present invention, a plurality of formed bodies (for instance, ten formed bodies) 2 are arranged inside the sintering die 3 at a time, as depicted in FIG. 2, in order to boost the productivity. Here, in the present invention, the green sheet is configured to have thickness precision within a margin of error of plus or minus 5%, preferably plus or minus 3%, or more preferably plus or minus 1%, with reference to a designed value. As a result, according to the present invention, as the thickness d of each formed body 2 is uniform, there are no variations in proper pressure values or proper heating temperatures of respective formed bodies 2 and the sintering can be performed satisfactorily even in a case where a plurality of formed bodies (for instance, ten formed bodies) 2 are arranged inside the sintering die 3 and sintered at a time, as illustrated in FIG. 2. Meanwhile, if the green sheet is formed with low precision in thickness (for instance, more than plus or minus 5% with reference to the designed value), the thickness d of each formed body 2 is not uniform in the case where a plurality of formed bodies (for instance, ten formed bodies) 2 are arranged inside the sintering die 3 and sintered at a time as illustrated in FIG. 3. Accordingly, imbalanced pulse current passes through the respective formed bodies 2 and there occur variations in proper pressure values or proper heating temperatures and the sintering cannot be performed satisfactorily. Incidentally, in the case where the plurality of formed bodies 2 are simultaneously sintered, there may be employed an SPS apparatus having a plurality of sintering dies. There, formed bodies 2 may be respectively placed in the plurality of sintering dies of the SPS apparatus and then simultaneously sintered.

### [Method for Manufacturing Permanent Magnet]

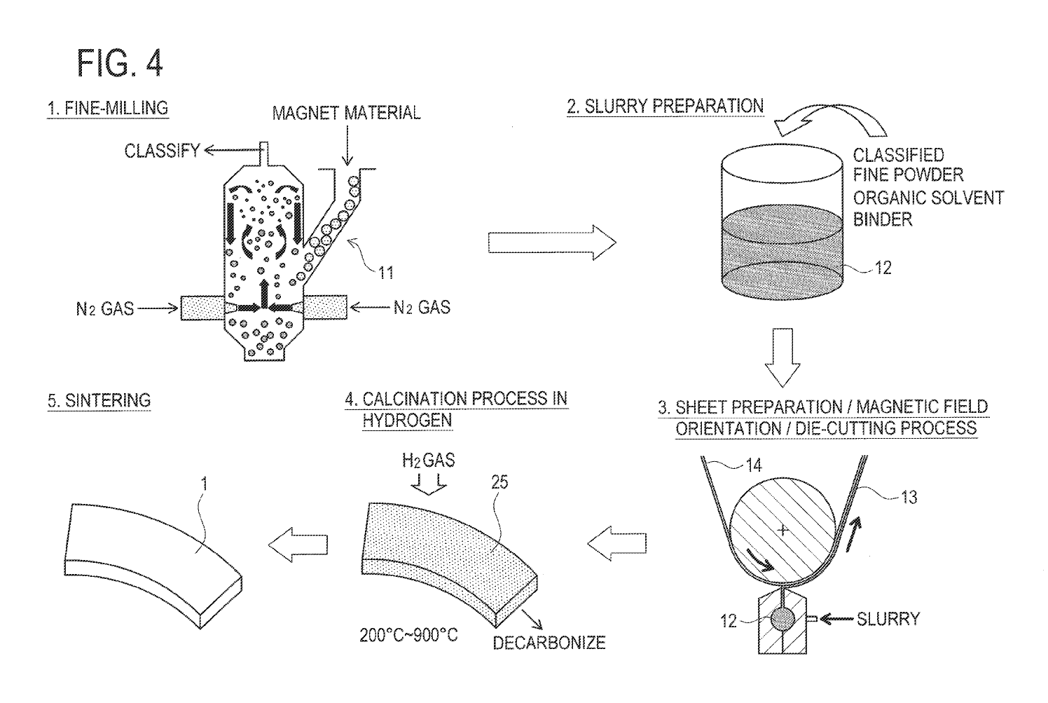

Next, a method for manufacturing the permanent magnet 1 according to the present invention will be described below with reference to FIG. 4. FIG. 4 is an explanatory view illustrating a manufacturing process of the permanent magnet 1 according to the present invention.

First, there is manufactured an ingot comprising Nd—Fe—B of certain fractions (for instance, Nd: 32.7 wt %, Fe (electrolytic iron): 65.96 wt %, and B: 1.34 wt %). Thereafter the ingot is coarsely milled using a stamp mill, a crusher, etc. to a size of approximately 200 μm. Otherwise, the ingot is dissolved, formed into flakes using a strip-casting method, and then coarsely milled using a hydrogen pulverization method.

Next, the coarsely milled magnet powder is finely milled with a jet mill 11 to form fine powder of which the average particle diameter is smaller than a predetermined size (for instance, 1.0 μm through 5.0 μm) in: (a) an atmosphere composed of inert gas such as nitrogen gas, argon (Ar) gas, helium (He) gas or the like having an oxygen content of substantially 0%; or (b) an atmosphere composed of inert gas such as nitrogen gas, Ar gas, He gas or the like having an oxygen content of 0.0001 through 0.5%. Here, the term “having an oxygen content of substantially 0%” is not limited to a case where the oxygen content is completely 0%, but may include a case where oxygen is contained in such an amount as to allow a slight formation of an oxide film on the surface of the fine powder. Incidentally, wet-milling may be employed for a method for milling the magnet material. For instance, in a wet method by a bead mill, using toluene or the like as a solvent, coarsely milled magnet powder may be finely milled to a predetermined size (for instance, 0.1 μm through 5.0 μm). Thereafter, the magnet powder contained in the organic solvent after the wet milling may be desiccated by such a method as vacuum desiccation to obtain the desiccated magnet powder. There may be configured to add and knead the binder to the organic solvent after the wet milling without removing the magnet powder from the organic solvent to obtain later described slurry 12. Incidentally, one or more kinds of organic solvents selected from a group of organic compounds consisting of hydrocarbons, as the solvent to be used for the wet-milling. For instance, hexane, pentane, benzene, xylene, a mixture thereof or the like may be used other than toluene.

Through using the above wet-milling, the magnetic material can be milled into still smaller grain sizes than those in the dry-milling. However, if the wet-milling is employed, there rises a problem of residual organic compounds in the magnet due to the organic solvent, even if the later vacuum desiccation vaporizes the organic solvent. However, this problem can be solved by removing carbons from the magnet through performing the later-described calcination process to decompose the organic compounds remaining with the binder by heat.

Meanwhile, a binder solution is prepared for adding to the fine powder finely milled by a jet mill 11 or the like. Here, as mentioned above, there can be used a hydrocarbon resin having a depolymerization property and an excellent thermal decomposition property, a long chain hydrocarbon or a mixture thereof as binder. Then, binder solution is prepared through dissolving the binder into an organic solvent. As the organic solvent to be used for dissolution, one or more kinds of organic solvents selected from a group of organic compounds consisting of hydrocarbons may be used, as discussed above. For instance, toluene, hexane, pentane, benzene, xylene, a mixture thereof or the like may be used. Specifically, toluene or hexane is used in the present invention.

Successively, the above binder solution is added to the fine powder classified at the jet mill 11. Through this, slurry 12 in which the fine powder of magnet raw material, the binder and the organic solvent are mixed is prepared. Here, the amount of binder solution to be added is preferably such that binder proportion to the amount of magnet powder and binder in total in the slurry after the addition is 1 wt % through 40 wt %, more preferably 2 wt % through 30 wt %, still more preferably 3 wt % through 20 wt %. For instance, 100 grams of 20 wt % binder solution is added to 100 grams of the magnet powder to prepare the slurry 12. Here, the addition of the binder solution is performed in an atmosphere composed of inert gas such as nitrogen gas, Ar gas or He gas. Incidentally, in a case the wet-milling is employed for milling the magnet powder, it is preferable to first mill the magnet powder wet and then add the binder to the organic solvent containing the milled magnet powder, so as to make the milled magnet powder into a slurry state.

Subsequently, a green sheet 13 is formed from the slurry 12 thus produced. The green sheet 13 may be formed by, for instance, a coating method in which the produced slurry 12 is spread on a supporting substrate 14 such as a separator as needed by an appropriate system and then desiccated. Incidentally, the coating method is preferably a method excellent in layer thickness controllability, such as a doctor blade system, a slot-die system, or a comma coating system. For realizing thickness precision, a slot-die system or a comma coating system is especially favorable as being excellent in layer thickness controllability (namely, as being a method capable of applying a layer with accurate thickness on a surface of a substrate). For instance, the following embodiment adopts a slot-die system. As supporting substrate 14, a silicone-treated polyester film is used. Further, a green sheet 13 is dried by being held at 90 degrees Celsius for 10 minutes and subsequently at 130 degrees Celsius for 30 minutes. Further, a defoaming agent may preferably be used in conjunction therewith to sufficiently perform defoaming treatment so that no air bubbles remain in a spread layer.

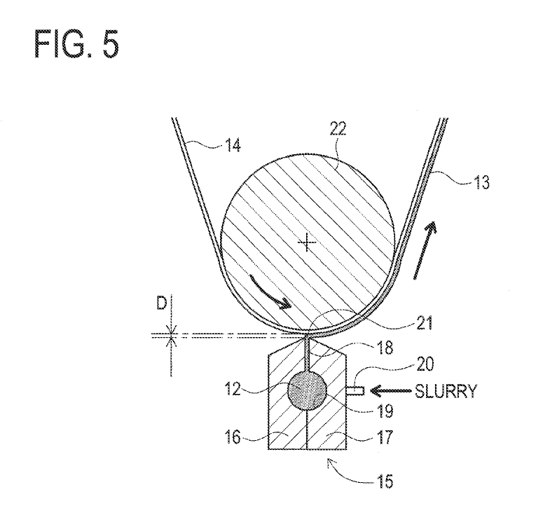

Here will be given a detailed description of the formation process of a green sheet 13 using a slot-die system referring to FIG. 5. FIG. 5 is an explanatory diagram illustrating the formation process of the green sheet 13 using the slot-die system.

As illustrated in FIG. 5, a slot die 15 used for the slot-die system is formed by blocks 16 and 17 put together. There, a gap between the blocks 16 and 17 serves as a slit 18 and a cavity (liquid pool) 19. The cavity 19 communicates with a die inlet 20 formed in the block 17. Further, the die inlet 20 is connected with a slurry feed system configured with a metering pump and the like (not shown), and the cavity 19 receives the feed of metered slurry 12 through the die inlet 20 by the metering pump and the like. Further, the slurry 12 fed to the cavity 19 is delivered to the slit 18, and discharged in a constant amount per unit of time at a predetermined coating width from a discharge outlet 21 of the slit 18, with a pressure which is uniform in transverse direction. Meanwhile, a supporting substrate 14 is conveyed along the rotation of a coating roll 22 at a predetermined speed. As a result, the discharged slurry 12 is laid down on the supporting substrate 14 with a predetermined thickness.

Further, in the formation process of the green sheet 13 by the slot-die system, it is desirable to measure the actual sheet thickness of the green sheet 13 after coating, and to perform feed back control of a gap D between the slot die 15 and the supporting substrate 14 based on the measured thickness. Further, it is desirable to minimize the variation in feed rate of the slurry supplied to the slot die 15 (for instance, suppress the variation within plus or minus 0.1%), and in addition, to also minimize the variation in coating speed (for instance, suppress the variation within plus or minus 0.1%). As a result, thickness precision of the green sheet can further be improved. Incidentally, the thickness precision of the formed green sheet is within a margin of error of plus or minus 5% with reference to a designed value (for instance, 4 mm), preferably within plus or minus 3%, or more preferably within plus or minus 1%.

Incidentally, a preset thickness of the green sheet 13 is desirably within a range of 0.05 mm through 10 mm. If the thickness is set to be thinner than 0.05 mm, it becomes necessary to accumulate many layers, which lowers the productivity. Meanwhile, if the thickness is set to be thicker than 10 mm, it becomes necessary to decrease the drying rate so as to inhibit air bubbles from forming at drying, which significantly lowers the productivity.

Further, a pulsed field is applied before drying to the green sheet 13 coated on the supporting substrate, in a direction intersecting a transfer direction. The intensity of the applied magnetic field is 5000 [Oe] through 150000 [Oe], or preferably 10000 [Oe] through 120000 [Oe]. Incidentally, the direction to orient the magnetic field needs to be determined taking into consideration the magnetic field direction required for the permanent magnet 1 formed from the green sheet 13, but is preferably in-plane direction.

Then, the green sheet 13 is die-cut into a desired product shape (for example, the fan-like shape shown in FIG. 1) to form a formed body 25.

Thereafter, the formed body 25 thus formed is held at a binder-decomposition temperature for several hours (for instance, five hours) in a non-oxidizing atmosphere (specifically in this invention, a hydrogen atmosphere or a mixed gas atmosphere of hydrogen and inert gas) and a calcination process in hydrogen is performed. The hydrogen feed rate during the calcination is, for instance, 5 L/min, if the calcination is performed in the hydrogen atmosphere. By the calcination process in hydrogen, the binder can be decomposed into monomers through depolymerization reaction, released therefrom and removed. Namely, so-called decarbonization is performed in which carbon content in the formed body 25 is reduced. Furthermore, calcination process in hydrogen is to be performed under such a condition that carbon content in the formed body 25 is 1000 ppm or lower, or more preferably 500 ppm or lower. Accordingly, it becomes possible to densely sinter the permanent magnet 1 as a whole in the following sintering process, and the decrease in the residual magnetic flux density or in the coercive force can be prevented.

The binder-decomposition temperature is determined based on the analysis of the binder decomposition products and decomposition residues. In particular, the temperature range to be selected is such that, when the binder decomposition products are trapped, no decomposition products except monomers are detected, and when the residues are analyzed, no products due to the side reaction of remnant binder components are detected. The temperature differs depending on the type of binder, but may be set at 200 through 900 degrees Celsius, or more preferably 400 through 600 degrees Celsius (for instance, 600 degrees Celsius). Further, in a case the magnet raw material is milled in an organic solvent by wet-milling, the calcination process is performed at a decomposition temperature of the organic compound composing the organic solvent as well as the binder decomposition temperature. Accordingly, it is also made possible to remove the residual organic solvent. The decomposition temperature for an organic compound is determined based on the type of organic solvent to be used, but basically the organic compound can be thermally decomposed in the above binder decomposition temperature.

Thereafter, a sintering process is performed in which the formed body 25 calcined in the calcination process in hydrogen is sintered. In the present invention, pressure sintering is applied to the calcined formed body 25. The pressure sintering includes, for instance, hot pressing, hot isostatic pressing (HIP), high pressure synthesis, gas pressure sintering, spark plasma sintering (SPS) and the like. However, it is preferable to adopt the spark plasma sintering which is uniaxial pressure sintering in which pressure is uniaxially applied and also in which sintering is preformed by electric current sintering so as to prevent grain growth of the magnet particles during the sintering and also to prevent warpage formed in the sintered magnet.

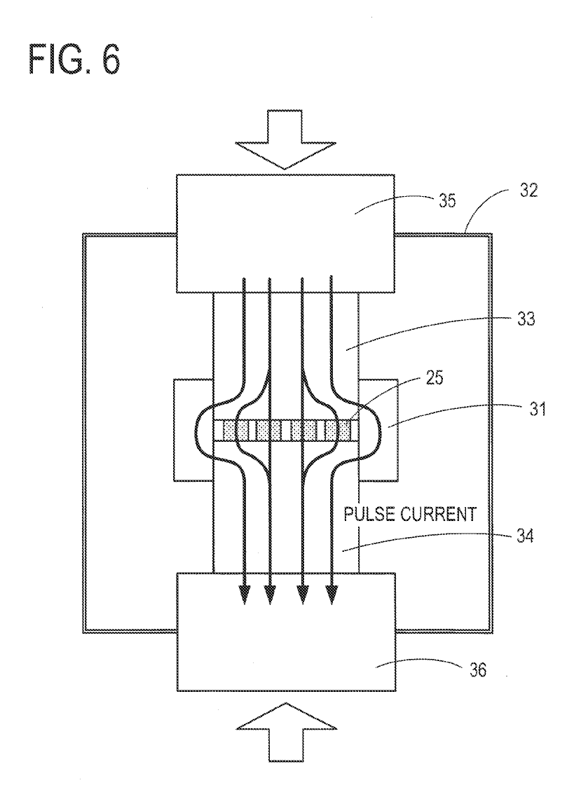

Here will be given a detailed description of the pressure sintering process of a formed body 25 using the SPS method, referring to FIG. 6. FIG. 6 is a schematic diagram depicting the pressure sintering process of the formed body 25 using the SPS method.

When performing the spark plasma sintering as illustrated in FIG. 6, first, the formed body 25 is put in a graphite sintering die 31. Incidentally, the above calcination process in hydrogen may also be performed under the state where the formed body 25 is put in the sintering die 31. Then, the formed body 25 put in the sintering die 31 is held in a vacuum chamber 32, and an upper punch 33 and a lower punch 34 also made of graphite are set thereat. After that, using an upper punch electrode 35 coupled to the upper punch 33 and a lower punch electrode 36 coupled to the lower punch 34, pulsed DC voltage/current being low voltage and high current is applied. At the same time, a load is applied to the upper punch 33 and the lower punch 34 from upper and lower directions using a pressurizing mechanism (not shown). As a result, the formed body 25 put inside the sintering die 31 is sintered while being pressurized. Further, the spark plasma sintering is preferably executed to a plurality of formed bodies (for instance, ten formed bodies) 25 simultaneously, so that the productivity may be improved. Incidentally, at the simultaneous spark plasma sintering to the plurality of formed bodies 25, the plurality of formed bodies 25 may be put in one sintering die 31, or may be arranged in different sintering dies 31, respectively. Incidentally, in the case that the plurality of formed bodies 25 are respectively arranged in different sintering dies 31, an SPS apparatus provided with a plurality of sintering dies 31 is used to execute sintering. There, the upper punch 33 and the lower punch 34 for pressing the formed bodies 25 are configured to be integrally used for the plurality of sintering dies 31 (so that the pressure can be applied simultaneously by the upper punch 33 and the lower punch 34) which are integrally-moving).

Incidentally, the detailed sintering condition is as follows:
Pressure value: 30 MPa
Sintering temperature: raised by 10 deg. C. per min. up to 940 deg. C. and held for 5 min.
Atmosphere: vacuum atmosphere of several Pa or lower.

After the above spark plasma sintering, the formed body 25 is cooled down, and again undergoes a heat treatment in 600 through 1000 degrees Celsius for two hours. As a result of the sintering, the permanent magnet 1 is manufactured.

### EMBODIMENTS

Here will be described on embodiments according to the present invention referring to comparative examples for comparison.

### Embodiment 1

In Embodiment 1, there is used a Nd—Fe—B-based magnet and alloy composition thereof is Nd/Fe/B=32.7/65.96/1.34 in wt %. The magnet material is milled through dry-milling using a jet mill. Polyisobutylene as binder and toluene as solvent have been used to prepare a binder solvent. 100 grams of binder solvent containing 20 wt % of binder has been added to 100 grams of magnet powder so as to obtain slurry in which the proportion of the binder is 16.7 wt % with reference to the total weight of the magnet powder and the binder. After that, the slurry has been applied onto a substrate by means of a slot dye system to form a green sheet and the green sheet has been die-cut into a desired shape for product. Further, the die-cut green sheet undergoes a calcination process and then is sintered with a spark plasma sintering (pressure value: 30 MPa; sintering temperature: raised by 10 degrees Celsius per minute up to 940 degrees Celsius and held for 5 minutes). Other processes are the same as the processes in [Method for Manufacturing Permanent Magnet] mentioned above.

### Embodiment 2

The magnet material is milled through wet-milling using a bead mill. Specifically, the magnet material is first milled with Ø2 mm zirconia beads for two hours, and then milled with Ø5 mm zirconia beads for two hours. Toluene is used as organic solvent at milling. After the wet-milling, polyisobutylene is added as binder to the organic solvent containing the milled magnet powder, to form similar slurry. Other conditions are the same as in embodiment 1.

### Comparative Example 1

The solvent of 8:2 mixture of toluene and ethyl acetate is used as the organic solvent. Other conditions are the same as the conditions in embodiment 1.

### Comparative Example 2

The solvent of 8:2 mixture of toluene and methanol is used as the organic solvent. Other conditions are the same as the conditions in embodiment 1.

### Comparative Example 3

The solvent of 8:2 mixture of toluene and ethyl acetate is used as the organic solvent. Other conditions are the same as the conditions in embodiment 2.

### Comparative Example 4

The solvent of 8:2 mixture of toluene and methanol is used as the organic solvent. Other conditions are the same as the conditions in embodiment 2.

### Comparison of Embodiment 1 with Comparative Examples 1 and 2

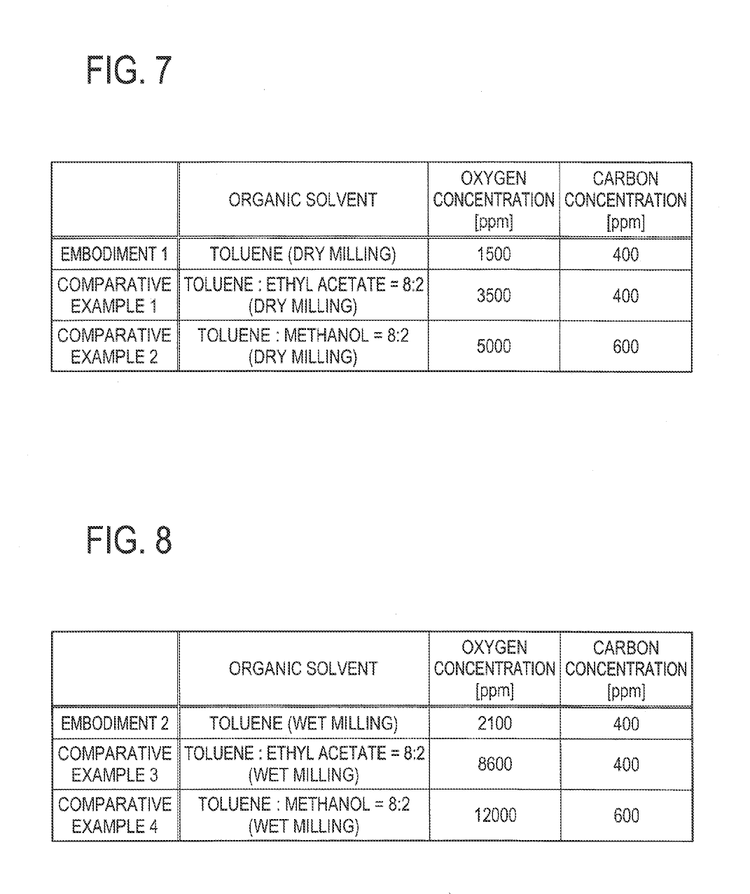

There have been measured oxygen concentration [ppm] and carbon concentration [ppm] remaining in respective magnets of embodiment 1 and comparative examples 1 and 2. FIG. 7 shows measurement results regarding respective embodiment and comparative examples.

It is apparent from the measurement results that oxygen content remaining in the magnet can be reduced in embodiment 1 using only toluene being an organic compound of hydrocarbon as the organic solvent when producing the slurry, in comparison with comparative example 1 or 2 using ethyl acetate or methanol being an organic compound containing oxygen atoms besides hydrogen and carbon, as the organic solvent. Specifically in the permanent magnet of embodiment 1, oxygen content remaining in the sintered magnet can be reduced to 3000 ppm or lower, more specifically, 2000 ppm or lower. Consequently, such low oxygen content can prevent Nd from binding to oxygen to form a Nd oxide and also prevent alpha iron from separating out. Accordingly, higher values of residual magnetic flux density and those of coercive force can be obtained in the embodiment compared to the comparative examples. Accordingly, through using one or more kinds of organic solvents selected from a group of organic compounds consisting of hydrocarbons in a case of using the dry-milling in manufacturing a permanent magnet, the oxygen amount contained in the magnet at the sintering can be reduced, so that the magnetic properties can be prevented from deteriorating.

### Comparison of Embodiment 2 with Comparative Examples 3 and 4

There have been measured oxygen concentration [ppm] and carbon concentration [ppm] remaining in respective magnets of embodiment 2 and comparative examples 3 and 4. FIG. 8 shows measurement results regarding respective embodiment and comparative examples.

It is apparent from the measurement results that oxygen content remaining in the magnet can be reduced significantly in embodiment 2 using only toluene being an organic compound of hydrocarbon as the organic solvent at wet milling, in comparison with comparative example 3 or 4 using ethyl acetate or methanol being an organic compound containing oxygen atoms besides hydrogen and carbon, as the organic solvent. Specifically in the permanent magnet of embodiment 1, oxygen content remaining in the sintered magnet can be reduced to 3000 ppm or lower, more specifically, 2500 ppm or lower. Consequently, such low oxygen content can prevent Nd from binding to oxygen to form a Nd oxide and also prevent alpha iron from separating out. Accordingly, higher values of residual magnetic flux density and those of coercive force can be obtained in the embodiment compared to the comparative examples. Accordingly, through using one or more kinds of organic solvents selected from a group of organic compounds consisting of hydrocarbons in a case of using the wet-milling in manufacturing a permanent magnet, the oxygen amount contained in the magnet at the sintering can be reduced, so that the magnetic properties can be prevented from deteriorating.

Further, as shown in FIGS. 7 and 8, it is apparent that carbon content contained in the magnet can be reduced significantly in a case of performing a hydrogen calcination process using polyisobutylene having an excellent thermal decomposition property as binder. Specifically in the permanent magnet of embodiment 1 or 2, owing to the hydrogen calcination process, carbon content remaining in the sintered magnet is reduced to 500 ppm or lower. Consequently, the entirety of the magnet can be sintered densely without making a gap between a main phase and a grain boundary phase. Further, decrease in the residual magnetic flux density can be prevented.

As described, according to the permanent magnet 1 and the manufacturing method of the permanent magnet 1 directed to the afore-mentioned embodiments, magnet material is milled into magnet powder, the thus obtained magnet powder and a binder of hydrocarbon are kneaded together with one or more kinds of organic solvents selected from a group of organic compounds consisting of hydrocarbons to prepare slurry 12. After that, the thus prepared slurry 12 is formed into a sheet-like shape so as to obtain a green sheet 13. After that, the thus obtained green sheet 13 is held for a predetermined length of time at binder decomposition temperature in a non-oxidizing atmosphere so as to remove the binder by causing depolymerization reaction or the like to the binder, which eventually changes into monomer. The green sheet from which the binder has been removed is sintered by raising temperature up to sintering temperature so as to complete the permanent magnet 1. Consequently, the thus sintered green sheet uniformly contracts and deformations such as warpage and depressions do not occur to the sintered green sheet. Further, the sintered green sheet having uniformly contracted gets pressed uniformly, which eliminates adjustment process to be conventionally performed after sintering and simplifies manufacturing process. Thereby, a permanent magnet can be manufactured with high dimensional accuracy. Further, even if such permanent magnets are manufactured with thinner design, increase in the number of manufacturing processes can be avoided without lowering a material yield.

Further, oxygen content remaining in the sintered magnet can be reduced by using one or more kinds of organic solvents selected from a group of organic compounds consisting of hydrocarbons as the organic solvent, and a binder of hydrocarbon. As a result, formation of metal oxide in the sintering process can be inhibited, thus preventing deterioration in magnetic properties.

Further, before the step of sintering the green sheet 13, the binder is decomposed and removed from the green sheet 13 by holding the green sheet 13 for a predetermined length of time at binder decomposition temperature in a non-oxidizing atmosphere. Thereby, carbon content in the magnet can be reduced previously. Consequently, previous reduction of carbon content can prevent alpha iron from separating out in a main phase of the sintered magnet and the entirety of the magnet can be sintered densely. Thereby, decrease in the coercive force can be prevented. Specifically, use of a polymer having an excellent thermal decomposition property as binder enables more secure reduction of the carbon content.

Further, in the step of calcination, the green sheet to which the binder has been mixed is held in a hydrogen atmosphere or a mixed gas atmosphere of hydrogen and inert gas for a predetermined length of time in temperature range of 200 through 900 degrees Celsius, more preferably, 400 through 600 degrees Celsius. Thereby, carbon content in the magnet can be reduced reliably.

Not to mention, the present invention is not limited to the above-described embodiments but may be variously improved and modified without departing from the scope of the present invention.

Further, of magnet powder, milling condition, mixing condition, calcination condition, sintering condition, etc. are not restricted to conditions described in the embodiments. Here, in one of the above described embodiments, magnet material is dry-milled by using a jet mill. In the other embodiment, magnet material is wet-milled by using a bead mill. Further, in a case of using the wet-milling for milling the magnet powder, the magnet powder is preferably made into a slurry state through adding the binder to the organic solvent containing the milled magnet powder. Further, the organic solvent to be used at the wet-milling is preferably one or more kinds of organic solvents selected from a group of organic compounds consisting of hydrocarbons. Meanwhile, the wet-milled magnet powder may first be desiccated and then mixed with the organic solvent and the binder to be made into a slurry state. However, in such a case, the organic solvent to be added to the desiccated magnet powder is preferably one or more kinds of organic solvents selected from a group of organic compounds consisting of hydrocarbons, likewise.

Further, in the above-mentioned embodiment, the green sheet is formed in accordance with a slot-die system. However, a green sheet may be formed in accordance with other system or molding (e.g., calendar roll system, comma coating system, extruding system, injection molding, doctor blade system, etc.), as long as it is the system that is capable of forming slurry into a green sheet on a substrate at high accuracy. Further, in the above embodiment, the magnet is sintered by SPS method; however, the magnet may be sintered by other pressure sintering methods (for instance, hot press sintering, etc.).

In the aforementioned embodiments, toluene or hexane is used as organic solvent to be added to the magnet powder; however, any organic solvent may be used as long as it is one or more kinds of organic solvents selected from a group of organic compounds consisting of hydrocarbons. For instance, pentane, benzene, xylene or a mixture thereof may be used.

Further, the calcination process may be omitted. Even so, the binder is thermally decomposed during the sintering process and certain extent of decarbonization effect can be expected. Alternatively, the calcination process may be performed in an atmosphere other than hydrogen atmosphere.

Further, in the aforementioned embodiments, a resin or a long chain hydrocarbon is used as binder, however, other materials may be used insofar as being a hydrocarbon material.

Description of the present invention has been given by taking the example of the Nd—Fe—B-based magnet. However, magnet made of other kinds of material (for instance, cobalt magnet, alnico magnet, ferrite magnet, etc.) may be used. Further, in the embodiments of present invention, the proportion of Nd component ratio with reference to the alloy composition of the magnet is set higher in comparison with Nd component ratio in accordance with the stoichiometric composition. The proportion of Nd component may be set the same as the alloy composition according to the stoichiometric composition.

### DESCRIPTION OF REFERENCE NUMERALS AND SIGNS

1 permanent magnet
11 jet mill
12 slurry
13 green sheet
25 formed body

1. A rare-earth permanent magnet manufactured through steps of:
milling magnet material into magnet powder;
preparing slurry by mixing the magnet powder with
a binder made of a hydrocarbon, and
one or more kinds of organic solvents selected from a group of organic compounds consisting of hydrocarbons;
obtaining a green sheet by forming the slurry into a sheet-like shape; and
sintering the green sheet.

2. The rare-earth permanent magnet according to claim 1 manufactured further through a step of decomposing and removing the binder from the green sheet by holding the green sheet for a predetermined length of time at binder decomposition temperature in a non-oxidizing atmosphere, before sintering the green sheet.

3. The rare-earth permanent magnet according to claim 2, wherein, in the step of decomposing and removing the binder, the green sheet is held for the predetermined length of time in a temperature range of 200 degrees Celsius to 900 degrees Celsius in a hydrogen atmosphere or a mixed gas atmosphere of hydrogen and inert gas.

4. The rare-earth permanent magnet according to claim 1, wherein:
in the step of milling the magnet material into the magnet powder, the magnet material is milled wet in the one or more kinds of organic solvents; and
in the step of preparing the slurry, the binder is added to the one or more kinds of organic solvents containing the magnet powder so that the slurry is prepared.

5. A manufacturing method of a rare-earth permanent magnet comprising steps of:
milling magnet material into magnet powder;
preparing slurry by mixing the magnet powder with
a binder made of a hydrocarbon, and
one or more kinds of organic solvents selected from a group of organic compounds consisting of hydrocarbons;
obtaining a green sheet by forming the slurry into a sheet-like shape; and
sintering the green sheet.

6. The manufacturing method of a rare-earth permanent magnet according to claim 5 further comprising a step of decomposing and removing the binder from the green sheet by holding the green sheet for a predetermined length of time at binder decomposition temperature in a non-oxidizing atmosphere, before sintering the green sheet.

7. The manufacturing method of a rare-earth permanent magnet according to claim 6, wherein, in the step of decomposing and removing the binder, the green sheet is held for the predetermined length of time in a temperature range of 200 degrees Celsius to 900 degrees Celsius in a hydrogen atmosphere or a mixed gas atmosphere of hydrogen and inert gas.

8. The manufacturing method of a rare-earth permanent magnet according to claim 5, wherein:
in the step of milling the magnet material into the magnet powder, the magnet material is milled wet in the one or more kinds of organic solvents; and
in the step of preparing the slurry, the binder is added to the one or more kinds of organic solvents containing the magnet powder so that the slurry is prepared.
